(19) United States
(12) Patent Application Publication
(10) Pub. No.: US 2008/0201517 A1
(43) Pub. Date: Aug. 21, 2008

(54) Method for the conversion of Logical Into Real Block Addresses in Flash Memories

(76) Inventor: Reinhard Kuhne, Reichenau (DE)

Correspondence Address: BROWDY AND NEIMARK, P.L.L.C.;624 NINTH STREET, NW, SUITE 300, WASHINGTON, DC, 20001-5303, US

(21) Appl. No.: 11/813,548

(22) PCT Filed: Dec. 20, 2005
(86) PCT No.: PCT/EP2005/056985

§ 371 Date: Mar. 17, 2008

(30) Foreign Application Priority Data
Jan. 7, 2005 (DE) 10 2005 001 038.5

(51) Int. Cl. G06F 12/00

(52) U.S. Cl. 711/100; 711/E12.001

(57) ABSTRACT

The invention relates to a method for managing memory blocks in a non-volatile memory system comprising individually erasable memory blocks which can be addressed with the aid of real memory block numbers (RBN) and can be addressed by converting the address from a logical block number (LBN) into one of the real memory block numbers, respectively, with the aid of allocator tables (LTP, PTR). The logical block number (LBN) is allocated to a physical memory block number (PBN) via a first table (LTP) while the physical memory block number (PBN) is allocated to a real memory block number (RBN) via a second table (PTR), one or several real memory blocks being addressed with the aid of one physical memory block number (PBN).

The invention describes a method for managing memory blocks in a non-volatile memory system comprising individually erasable memory blocks which can be addressed with the aid of real memory block numbers, and can be addressed by converting the address from a logical block number into one of the real memory block numbers, respectively, with the aid of allocator tables.

Flash memories are used with many computer systems, in particular also in exchangeable memory cards for digital cameras and portable computers. Flash memories are organized in memory blocks with many sectors each. Substantial properties of these memories are, that only a limited number of write and delete operations is possible, and that the deletion is possible only in units of memory blocks, which contain several sectors. The writing and deleting processes take much more time (up to the factor 50) than reading.

The conversion of logical memory addresses into real memory addresses is well-known with flash memory systems, for instance from the DE 102 27 256 for the even wear of real memory blocks, or from the DE 103 41 616 for the management of defective real memory blocks.

With constantly growing storage capacity, the memory block addresses of the memory systems get longer, and the conversion tables of logical into real memory block addresses become larger.

Small memory block sizes, of 4 Kbytes for instance, are favourable, in order to minimize the loss caused by non-used space in the memory blocks in file systems with many small files. Frequently larger memory blocks, from 32 Kbytes to 256 Kbytes, are then built, in order to correspondingly keep the conversion tables smaller. In doing so, it is important to limit the address pointers in the tables to 16 bits in order to accomplish the address conversion fast and efficiently.

It is the object of the invention to manage efficiently memory systems of varying dimensions with uniform table structures and varying real memory block sizes.

This object is met in such a way, that the logical block number is allocated to a physical memory block number via a first table, and the physical memory block number is allocated to a real memory block number via a second table, one or several real memory blocks being addressed with the aid of one physical memory block number.

Favourable embodiments of the invention are indicated in the subclaims.

The second table allocates one or several real memory blocks to a physical memory block number, the size of the real memory blocks being given by the structuring of the memory chips used. Chips with block sizes of 4 Kbytes or with block sizes of 32 Kbytes, 64 Kbytes, 128 Kbytes or with still larger real blocks are used.

It is an advantage of the method that the first address conversion of logical memory block numbers into physical memory block numbers is accomplished independently of the size of the real memory blocks. The method can thus be applied to many memory systems of varying dimensions. The management of defective real memory blocks is done exclusively by means of the second address conversion table, by replacing the numbers of defective memory blocks with the numbers of functioning memory blocks in the second table. The numbers of defective memory blocks are then recorded in unused areas of the second table.

Building the physical memory blocks in the first address conversion table has the advantage that large memory blocks are built from several real memory blocks, which are jointly subjected to one memory operation, independent of the location of the real memory blocks in the memory chips. This increases the speed of processing of the memory operations.

The speed of processing of the memory operations is further increased, if the real memory blocks are located in different memory chips. Then the memory operations, like >>write<< or >>delete<< are done simultaneously in the memory chips (interleaving). With some types of memory chips, a large number of memory blocks are pooled in so called banks, which can execute memory operations simultaneously. If then the physical memory blocks each consist exclusively of real memory blocks, which are located in different banks and in different memory chips, the simultaneous processing of memory operations is done in all real memory blocks, and a maximum execution speed is reached.

The tables for the address conversion are stored in non-volatile real memory blocks reserved for the administration. They are thus available even after a power failure. For the fast processing of the memory operations, copies of currently needed parts of the address conversion tables are stored additionally in an internal fast RAM memory (caching).

The numbers of the memory blocks reserved for the administration of the memory system are not recorded in the first table for address conversion. Consequently they can not be addressed from the outside via logical sector numbers.

A small percentage of memory blocks, about 3%, are reserved for the substitution of memory blocks which have become defective. The numbers of these real memory blocks, too, are not recorded in the first table for address conversion. Consequently they can not be addressed from the outside via logical sector numbers.

A favourable embodiment of the invention is described in the figures by way of example.

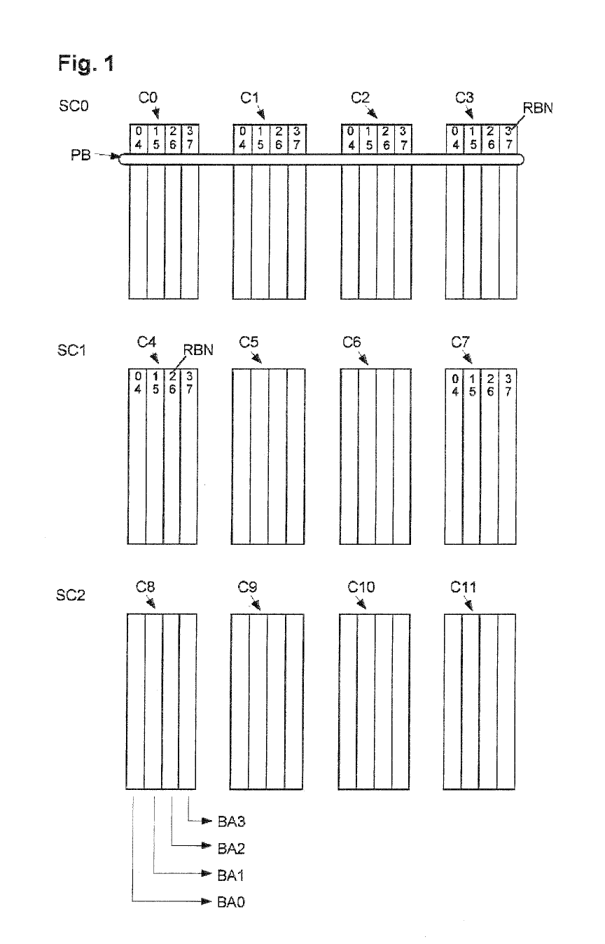

FIG. 1 shows a block diagram of a memory system with 12 memory chips.

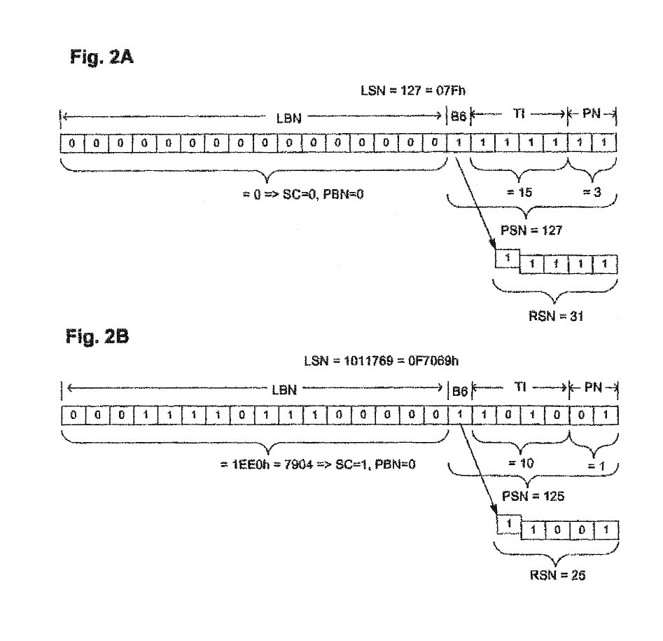

FIG. 2 shows the structure of the two address conversion tables.

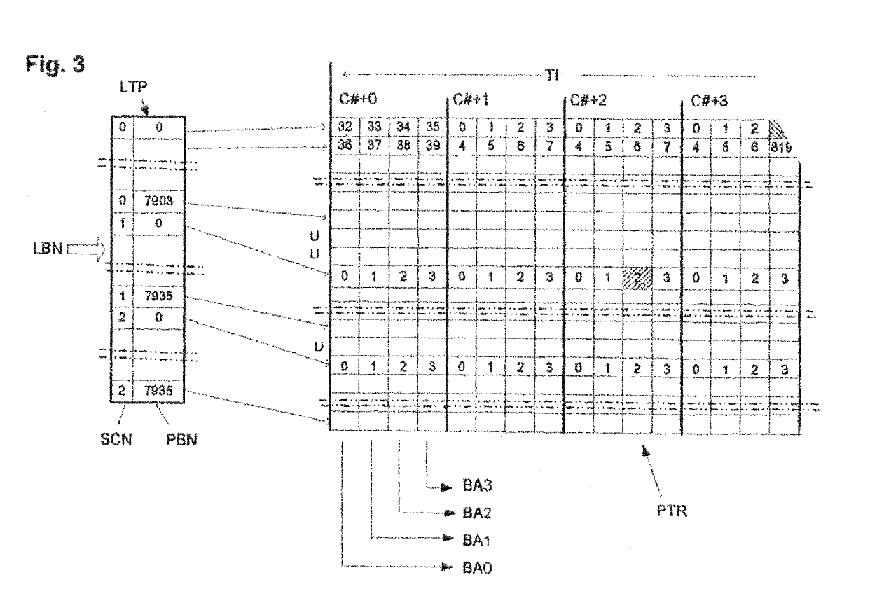

FIG. 3 shows two examples for the conversion from logical addresses into real addresses.

FIG. 1 shows a block diagram for a memory system with twelve memory chips C0 to C11 with a storage capacity of 128 megabyte each. Consequently the memory system has a size of 1.5 gigabyte. Memory operations like >>read<< and >>write<< can be done with logical sectors of 512 Byte each. Eight real memory sectors of 512 Byte are combined to real blocks of 4 Kbytes, which are jointly deletable.

The twelve memory chips C0 to C11 have 262144 real sectors each, every four of which build a page. Each two pages build a real memory block, said memory blocks being arranged in four banks BA0 to BA3 each. Four memory chips respectively are combined logically into a superchip SC0 to SC3. A physical memory block PB then contains sixteen real memory blocks consisting of the four chips of one superchip of four independent banks each, together 64 Kbytes. In the case shown here the physical block PB is built in the superchip SC0 with the chips C0 to C3 with respectively one real memory block in every single of the four times four banks BA0 to BA3. Consequently all real memory blocks of the physical block PB can process a memory operation simultaneously.

FIGS. 2A and 2B show two examples of address conversions.

In FIG. 2A a memory operation on the logical sector LSN with the number 127 is to be accomplished. For that purpose the logical sector number is split into the components sector number in a page PN, tuple index TI, and logical block number LBN. Since sixteen blocks with eight sectors each are combined to one physical sector, a physical sector number between 0 and 127 results. The real sector numbers in a page are not necessarily sequential, but can show gaps depending on the size of the page. It is assumed here, that a page consists of four real sectors, and two pages each are combined to form a real block. Since sequential pages are arranged in sequential banks, gaps emerge in the numbering of the real sectors in a real block according to the number of the banks and chips. In this example therefore, for the creation of the real sector number the Bit6 B6 is regarded as the highest bit of the real sector number. In this case the logical block number LBN equals 0, the tuple index TI equals 15 and the page number PN equals 3. The physical sector number PSN becomes 127. The bit B6 is used as the fifth bit of the real sector number RSN. Thus the real sector number RSN equals 31. The logical block number LBN indexes the first table LTP from FIG. 3, and supplies the superchip number SC=0 and the physical block number PBN=0.

In the same way the logical sector number 1011769 in FIG. 2B is split up. Here the page number PN becomes 1, the tuple index TI=10 and the logical block number LBN=7904. The physical sector number has the value 125. The bit B6 is used as the fifth bit of the real sector number RSN. Thus the real sector number RSN becomes 25.

The logical block number LBN indexes the first table LTP from FIG. 3 and supplies the superchip number SC=1 and the physical block number PBN=0.

In FIG. 3 the structure of the two tables LTP and PTR is shown. In the first table for address conversion LTP the logical block number LBN is converted into the address of a physical block, which consists of the components superchip number SCN and physical block number PBN. In the example presented here three superchips with the numbers 0 to 2 are present. The superchip number is thus 2 bits long. A physical block number consists of thirteen bits and can take values from 0 to 8191 thereby. In order to leave space for 32 administrative blocks and in each case 256 reserve blocks, the values can go up only to 7903 or respectively to 7935.

As shown in FIG. 2, the logical block number LBN in this example is 16 bits long and can take on values between 0 and 24319, according to the sum of the physical blocks of the three superchips SC0 to SC2.

The pointers from the first table LTP serve as index in the second table PTR. They point in each case to a tuple of sixteen real blocks, which are arranged in four times four banks BA0 to BA3. A tuple is arranged in four chips of a superchip. Thus a table with 16 columns results, in which the real block numbers of a bank are indicated respectively. Values between 0 and 7903 or 7935 respectively can be indicated, as long as no spare blocks were registered. In this manner for instance a spare block EB is registered in the second line at last position, which has then a larger block number. The block numbers can only have values modulo of the bank number. By administrative operations however, the block numbers can arbitrarily be interchanged within the banks. The lines of the table PTR, which can not be addressed with the aid of a physical block number, are unused, here characterized by a U in each case.

The real memory blocks, which can be addressed by the two examples from FIG. 2, are marked in the table by shading. The logical sector number LSN=127 addresses here the block 3 in the first line of the table PTR over SCN=0 and PBN=0 with the tuple index TI=15, and belongs to chip 0*4+3=3. The logical sector number LSN=1011769 addresses here the block 2 over SCN=1 and PBN=0 with the tuple index TI=10, and belongs to chip 1*4+2=6.

### REFERENCE SIGNS

BAn—memory blank number
Cn—chip number
EB—spare block
LBN—logical block number
LSN—logical sector number
LTP—first allocator table (logtophys)
PBn—physical block number
PTR—second allocator table (phystoreal)
RBN—real block number
RSN—real sector number
PN—page number
PSN—physical sector number
SCn—super chip number
SN—sector number
TI—tuple index
U—unused physical blocks

1. Method for managing memory blocks in a non-volatile memory system comprising individually erasable memory blocks which can be addressed with the aid of real memory block numbers (RBN), and can be addressed by converting the address from a logical block number (LBN) into one of the real memory block numbers, respectively, with the aid of allocator tables (LTP, PTR), characterized in that
the logical block number (LBN) is allocated to a physical memory block number (PBN) via a first table (LTP), and
the physical memory block number (PBN) is allocated to a real memory block number (RBN) via a second table (PTR),
one or several real memory blocks being addressed with the aid of one physical memory block number (PBN).

2. Method according to claim 1, characterized in that memory operations are carried out at once on all real memory blocks of a physical memory block number (PBN).

3. Method according to claim 1, characterized in that the real memory blocks, which are addressed with the aid of a physical memory block number (PBN), are located in different memory chips (SCn) and/or memory banks (Ban), and can be processed simultaneously.

4. Method according to claim 1, characterized in that the numbers of defective real memory blocks in the second table (PTR) are replaced by the numbers of functioning real memory blocks.

5. Memory system comprising individually erasable memory blocks which can be addressed with the aid of real memory block numbers (RBN), and can be addressed by converting the address from a logical block number (LBN) into one of the real memory block numbers, respectively, with the aid of allocator tables (LTP, PTR), characterized in that the address conversion tables according to one of the above claims are stored in memory blocks which are reserved for the administration of the memory system.

6. Memory system according to claim 5, characterized in that currently needed parts of the two address conversion tables (LTP, PTR) are additionally held in a RAM memory.

7. Memory system according to claim 5, characterized in that the numbers of the memory blocks reserved for the administration are not recorded for address conversion in the first table (LTP).

8. Memory system according to claim 5, characterized in that the numbers of the functioning memory blocks which are provided to substitute defective memory blocks are not recorded for address conversion in the first table (LTP).
